(19) United States
(12) Patent Application Publication
(10) Pub. No.: US 2015/0228987 A1
(43) Pub. Date: Aug. 13, 2015

(54) MEMBRANE ELECTRODE ASSEMBLY AND FUEL CELL COMPRISING ASSEMBLY OF THIS TYPE

(71) Applicant: Volkswagen Aktiengesellschaft, Wolfsburg (DE)

(72) Inventors: Benno ANDREAS-SCHOTT, Triangel (DE); Thorsten HICKMANN, Osterode (DE)

(73) Assignee: Volkswagen Aktiengesellschaft, Wolfsburg (DE)

(21) Appl. No.: 14/696,814

(22) Filed: Apr. 27, 2015

Related U.S. Application Data
(63) Continuation of application No. PCT/EP2013/067155, filed on Aug. 16, 2013.

(30) Foreign Application Priority Data
Oct. 25, 2012 (DE) 10 2012 020 947.9

(51) Int. Cl. H01M 8/02

(52) U.S. Cl. CPC H01M 8/0276; H01M 8/0202

(57) ABSTRACT

A membrane electrode assembly for a fuel cell. The membrane electrode assembly has a membrane electrode unit and an integrally formed seal with a first sub-section and a second subsection. The membrane electrode unit has a perforation, along which the seal extends on both faces of the membrane unit. The first sub-section of the seal is situated on a first flat face and the second sub-section on a second flat face of the membrane electrode unit and the two sub-sections are integrally joined through the perforation. A fuel cell is also provided having a plurality of membrane electrode assemblies.

This nonprovisional application is a continuation of International Application No. PCT/EP2013/067155, which was filed on Aug. 16, 2013, and which claims priority to German Patent Application No. 10 2012 020 947.9, which was filed in Germany on Oct. 25, 2012, and which are both herein incorporated by reference.

### BACKGROUND OF THE INVENTION

1. Field of the Invention

The present invention relates to a membrane electrode arrangement for a fuel cell, comprising a membrane electrode assembly and a one-piece seal which includes two subsections. The invention also relates to a fuel cell comprising a plurality of membrane electrode arrangements according to the invention.

2. Description of the Background Art

Fuel cells use a chemical conversion of a fuel to water with the aid of oxygen to generate electrical energy. For this purpose, fuel cells contain a membrane electrode assembly (MEA for membrane electrode arrangement) as a core component, which is an assembly of an ion-conducting, in particular proton-conducting, membrane and an electrode disposed on each side of the membrane (anode and cathode). The membrane electrode assembly may also include gas diffusion layers, which are usually disposed on both sides of the membrane electrode assembly on the sides of the electrodes facing away from the membrane. Typically, the fuel cell is formed by a large number of stacked MEAs, whose electrical outputs add up. During the operation of the fuel cell, the fuel, in particular hydrogen H₂, or a hydrogen-containing gas mixture, is supplied to the anode, where an electrochemical oxidation of H₂ to H⁺ takes place by emitting electrons. A (hydrous or anhydrous) transfer of the protons H+ from the anode compartment to the cathode compartment takes place with the aid of the electrolyte or the membrane, which separates the reaction chambers gas-tight from each other and electrically insulates them. The electrons provided to the anode are supplied to the cathode over an electrical line. Oxygen, or an oxygen-containing gas mixture, is supplied to the cathode so that a reduction from O₂ to O²⁻ takes place by absorbing the electrons. At the same time these oxygen anions react with the protons transported through the membrane in the cathode compartment, forming water. By directly converting chemical energy into electrical energy, fuel cells achieve an improved efficiency compared to other electricity generators by circumventing the Carnot factor.

The currently most advanced fuel cell technology is based on polymer electrolyte membranes (PEM), in which the membrane itself comprises a polymer electrolyte. Acid-modified polymers, in particular perfluorinated polymers, are used. The most common representative of this class of polymer electrolytes is a membrane made of a sulfonated polytetrafluoroethylene copolymer (trade name: Nafion; copolymer of tetrafluoroethylene and a sulfonyl fluoride derivative of a perfluoroalkyl vinyl ether). The electrolytic conduction takes place with the aid of hydrated protons, which is why proton conductivity is conditional on the presence of water and a humidifying of the operating gases is necessary during the operation of the PEM fuel cell. Due to the need for water, the maximum operating temperature of these fuel cells under standard pressure is limited to less than 100° C. To distinguish between these fuel cells and high-temperature polymer electrolyte membrane fuel cells (HT-PEM fuel cells), whose electrolytic conductivity is based on an electrolyte which is bound by electrostatic complex binding to a polymer structure of the polymer electrolyte membrane (for example, phosphoric acid-doped polybenzimidazole (PBI) membranes) and which are operated at temperatures of 160° C., this type of fuel cell is also referred to as a low-temperature polymer electrolyte membrane fuel cell (LT-PEM fuel cell).

As mentioned at the outset, the fuel cell is formed by a large number of individual cells arranged in a stack, which are referred to as a fuel cell stack. As a rule, bipolar plates are disposed between the membrane electrode assemblies, which ensure that the individual cells are supplied with the operating media, i.e., the reactants and usually also a cooling fluid. The bipolar plates also ensure an electrically conductive contact between the membrane electrode assemblies.

EP 2 201 157 B1 describes a bipolar plate which includes a sealing groove in an edge region of the bipolar plate, into which a seal, in particular an O-ring or a sealing ring and/or an applied seal, is introduced. The applied seal may be made of a soft plastic or an elastomer, for example in the multi-component injection molding method, and integrated into the bipolar plate.

In seal variants of this type, an offset of the bipolar plates with a membrane electrode assembly situated therebetween is unfavorable, since the relatively soft membrane electrode assembly may be easily deformed by the offset seals.

DE 20 2005 008 749 U1 describes a membrane electrode assembly having a polymer membrane, which is coated on both sides with an electrode structure and which projects between the electrode structures at least on one side in an edge region. The polymer membrane is partially embedded in a sealing element made of an elastomer material. The embedding preferably takes place by insert-molding or overcasting of the sealing element. In addition, the electrode structures are overlapped by the sealing element on both sides of the polymer membrane. The edge region of the polymer membrane is, in particular, integrally embedded into the sealing element. The sealing element may have sealing structures, e.g., in the form of sealing lips or sealing grooves, which surround, for example, an electrochemically active region of the membrane electrode assembly in a frame-like manner.

U.S. Pat. No. 6,057,054 describes a seal for a membrane electrode assembly, which penetrates porous electrode layers of the membrane electrode assembly. The seal is produced, e.g., with the aid of an injection molding method, preferably by applying a vacuum.

EP 1 608 033 B1 proposes a seal for a membrane electrode assembly having an improved rib structure, which is characterized by chambers which are offset from each other. This implements a more homogeneous rigidity distribution of the rib structure. The seal surrounds an edge area of the membrane electrode assembly, which is provided with an impregnation.

### SUMMARY OF THE INVENTION

It is therefore an object of the present invention to provide a membrane electrode arrangement having a seal which is reliably positioned on a membrane electrode assembly.

The membrane electrode arrangement according to an embodiment of the invention for a fuel cell comprises a membrane electrode arrangement which includes a membrane electrode assembly and a one-piece seal having a first subsection and a second subsection. The membrane electrode assembly has a perforation, along which the seal extends on both sides of the membrane electrode assembly, the first subsection of the seal being disposed on a first flat side and the second subsection being disposed on the second flat side of the membrane electrode assembly, and the two subsections being connected to each other as a single piece through the perforation.

Due to the membrane electrode arrangement according to the invention, the seal can be connected to the membrane electrode assembly in a form-locked manner. A large number of form-locked connecting points can be provided by the perforation and the seal passing through the perforation.

The membrane electrode assembly usually includes a membrane, which can be disposed at least partially between two electrodes. The membrane electrode assembly may also include gas diffusion layers, the membrane, together with the two electrodes, being disposed between the gas diffusion layers.

Orthographic projections of the two subsections onto the membrane electrode assembly (MEA) can include a congruent region, the membrane electrode assembly can have the perforation within the congruent region. The perforation can include recesses which pass through the MEA and have an arbitrary shape, e.g., a circular shape, an arbitrary arrangement, i.e., spaced a regular or irregular distance apart, and are of an arbitrary number, however having at least one recess. The seal can be provided with a circumferentially closed design, so that it surrounds one part of the membrane electrode assembly.

The two subsections can extend on both sides of the membrane electrode assembly, in that the first subsection extends along a first main surface (flat side) of the membrane electrode assembly and the second subsection extends along a second main surface (flat side) of the membrane electrode assembly.

The two subsections can have sealing surfaces, and the sealing surfaces of the first subsection and the second subsection essentially form congruent, orthographic projection regions on the membrane electrode assembly. Sealing surfaces are those surfaces which are designed to abut and seal a counter-surface, e.g., a bipolar plate. The sealing surfaces can be designed to be mirror-symmetrical with respect to the membrane electrode assembly (or a plane situated therein).

The membrane electrode assembly can have an edge reinforcement in one edge region, at least on its flat sides, the seal extending along the edge reinforcement. The edge region of the membrane electrode assembly may be reinforced by the reinforcement. In particular, the membrane electrode assembly can include an edge reinforcement on each of its two flat sides, between which the membrane of the membrane electrode assembly is disposed. In this case, the two subsections of the seal extend along the two edge reinforcements.

Materials for the edge reinforcement can be, for example, metal, paper or plastic. The edge reinforcement can be an edge reinforcing film made of a plastic. The edge reinforcing film can be a PEN film (polyethylene naphthalate), or the edge reinforcing film includes PEN.

According to an embodiment of the invention, the membrane electrode assembly can have a centering opening for the passage of a centering rod, and the membrane-electrode assembly comprises electrically isolating spacing elements, which are disposed around the centering opening and extend in a direction at right angles to a planar extension of the membrane electrode assembly. Due to the spacing elements, the short-circuit protection is increased in that a short circuit of two bipolar plates through the centering opening is prevented. In particular, the spacing elements can be made from the same material as the seal. The spacing elements may be advantageously overmolded onto the membrane electrode assembly substantially simultaneous with the seal in the same injection molding process. This results in cost savings, since no insulating plates are required as extra components. The spacing elements can be disposed on both sides of the membrane electrode assembly and are connected to each other as a single piece, in particular through another perforation. The spacing elements can completely surround the centering opening.

A chemically active region of the membrane electrode assembly, to which the operating media are applied during operation, can be surrounded by the seal. Due to the fact that the seal surrounds the chemically active region, reactants and reaction products are prevented from exiting a fuel cell which comprises the membrane electrode arrangement.

According to an embodiment of the invention, the electrodes of the membrane electrode assembly thus are at least essentially disposed within the chemically active region which is circumferentially surrounded by the seal. Due to this embodiment, an extension of the electrodes is at least essentially limited to the chemically active region, which saves material and costs. In this context, essentially can mean that a surface of the electrodes outside the chemically active region can be less than 30% or less than 15% of the surface of the electrodes within the chemically active region. The electrodes can be completely surrounded by the seal, i.e., no electrode surfaces are present outside the seal.

The membrane electrode assembly can include gas diffusion layers, which are disposed within the chemically active region completely surrounded by the seal. According to this embodiment, no gas diffusion layers are thus situated in the edge region outside the seal. Due to this embodiment, the gas diffusion layers are limited to the chemically active region inside the seal, which enables costs to be saved and a height of the membrane electrode arrangement to be reduced, since the seal is disposed outside the comparatively thick-walled gas diffusion layers.

In an embodiment of the invention, the edge region of the membrane electrode assembly, on which the seal is disposed, can include only the membrane and the two-sided edge reinforcement.

The membrane electrode assembly can have at least one opening for conducting operating media, which is circumferentially surrounded by the seal. Openings for conducting operating media are used to supply the membrane electrode assembly with operating media. As a result, the fuel cell stack may be supplied with the operating media in a compact and space-saving manner. The operating media include reactants, i.e., fuel (e.g., hydrogen) and oxidizing agents (e.g., oxygen or air) as well as cooling media, in particular cooling fluid. Moreover, reaction products (e.g., water) may be discharged via the channels of the membrane electrode assembly.

According to an embodiment of the invention, the chemically active region and the opening for the passage of operating media can be circumferentially surrounded by the seal and are easily separated from each other. The seal thus runs around the opening for the passage of operating media and around the chemically active region and separates the two from each other. The opening for the passage of operating media and the chemically active region are not doubled by the seal but are only easily separated from each other.

The seal can be integrally connected to the membrane electrode assembly. In addition to the form-locked connection between the seal and the membrane electrode assembly, an integral connection is thus also established between the seal and the membrane electrode assembly. This may typically be implemented by overmolding the seal onto the membrane electrode assembly, for example by partially melting the affected materials.

The seal preferably can have two sealing lips, which are formed by a corresponding profiling of the subsections. Two independent sealing lines are formed thereby, i.e., two sealing regions which act as double protection against leaks. The two sealing lips typically run all around a sealed region.

A fuel cell is also provided. The fuel cell comprises a plurality of alternately stacked bipolar plates and membrane electrode arrangements according to an embodiment of the invention. The subsections of the seal typically seal spaces between the membrane electrode assemblies and the bipolar plates. A particularly secure fixing of the seals within the fuel cell is facilitated by the membrane electrode arrangements according to the invention. Due to the fact that the seal is connected to the membrane electrode assembly in a form-locked manner, the two subsections of the seal are unable to slide on the membrane electrode assembly during an assembly or during an operation of the fuel cell.

The two subsections of one seal preferably engage with grooves of the assigned bipolar plates. A sealing region between the seal and the assigned bipolar plates is typically situated on a groove base of the groove. A form-locked fixing of the seals within the bipolar plates is thus established.

A manufacturing method of a membrane electrode arrangement according to the invention is furthermore provided, can include the following steps: Inserting the membrane electrode assembly into an opened injection molding die of an injection molding machine; Closing the injection molding die; Injecting a reaction mixture, which includes a polymer to be cross-linked or monomers and possibly a cross-linking agent into the injection molding die; Heating the reaction mixture for a predefined period of time to trigger the cross-linking and/or the polymerization; Opening the injection molding die; and Removing the membrane electrode arrangement.

A motor vehicle comprising the fuel cell according to the invention is furthermore provided. The fuel cell can be used to supply an electrical drive of the motor vehicle with electrical current.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a fuel cell;

FIG. 2 shows a perspective view of a supporting structure of the membrane electrode arrangement according to the invention; and

FIG. 3 shows a membrane electrode arrangement according to the invention in a normal view with enlarged detail and sectional views.

### DETAILED DESCRIPTION

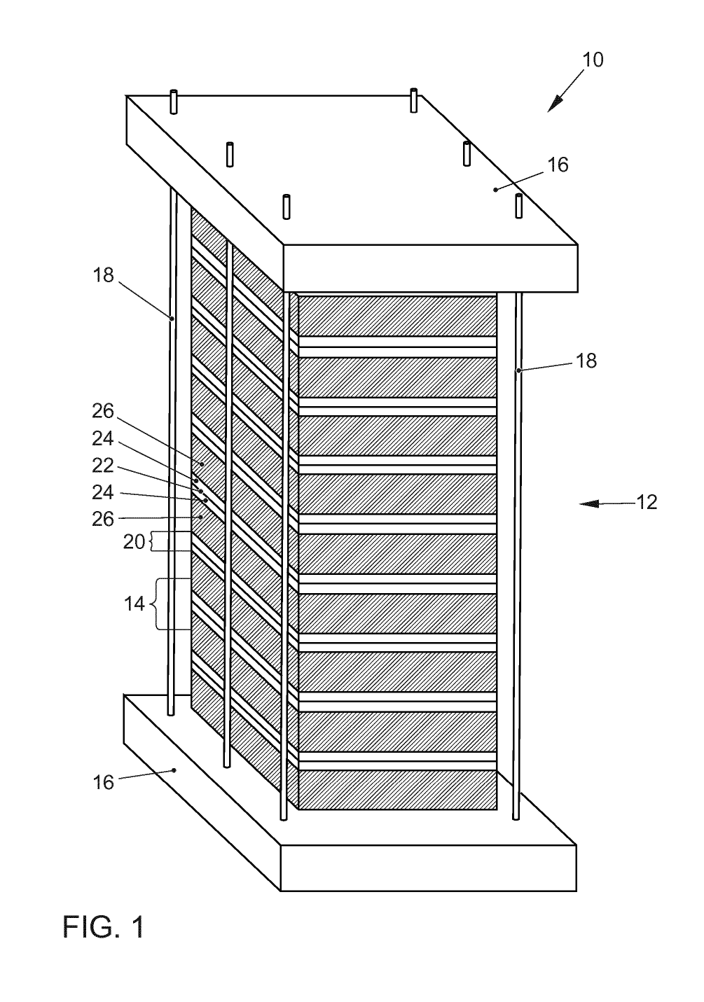

FIG. 1 shows a schematic view of a fuel cell 10, which comprises a fuel cell stack 12, including multiple individual cells 12, two end plates 16 and tension elements 18. Individual cells 14 each include one membrane electrode assembly 20, which includes a proton-conducting membrane 22 (polymer electrolyte membrane) and electrodes disposed on both sides of membrane 22 (anode and cathode; not illustrated). In addition, membrane electrode assembly 20 may include a gas diffusion layer 24 on each side, the electrodes in this case being disposed between membrane 22 and gas diffusion layers 24. The electrodes may be either coated onto both sides of membrane 22, or they may be connected to gas diffusion layers 24 as so-called gas diffusion electrodes. membrane electrode assemblies 20, in turn, are disposed between bipolar plates 26. Bipolar plates 26 supply membrane electrode assemblies 20 with reactants via their gas fusion layers 24, for which purpose suitable channels are usually provided in bipolar plates 26. In addition, bipolar plates 26 electrically conductively connect two adjacent membrane electrode assemblies 20, whereby they are connected in series. The two end bipolar plates 26 are also referred to as monopolar plates, since they supply adjacent membrane electrode assembly 20 only on one side and, for this purpose, have corresponding channels only on one of their sides.

Seals, which seal the anode and cathode compartments to the outside and prevent the operating media from exiting fuel cell stack 12, are disposed between membrane electrode assemblies 20 and bipolar plates 12.

To ensure the proper functioning of the seals as well as an electrically conductive contact of bipolar plates 26 to membrane electrode assemblies 20, even during vibrations, fuel cell stack 12 is pressed. This is usually done with the aid of two end plates 16, which are disposed on both ends of fuel cell stack 12, in combination with multiple tension elements 18. Tension elements 18 conduct tensile forces into end plates 16, so that end plates 16 press fuel cell stack 12 together.

The seals, which are disposed between membrane electrode assemblies 20 and bipolar plates 26, may be provided by membrane electrode assemblies 20 and/or bipolar plates 26 and, in particular, be connected to these components.

For this purpose, the seal may be vulcanized onto one or both sides of bipolar plate 26. The seal may furthermore be deposited onto bipolar plate 26 in the form of a sealing bead with the aid of a robot. The seal deposited by the robot may have substantial tolerances, which may result in leaks. Up to now, this problem has been counteracted by optimizing the process of depositing the sealing bead with the robot.

The fuel cell according to an embodiment of the invention can have a structure according to FIG. 1 that it includes membrane electrode arrangements.

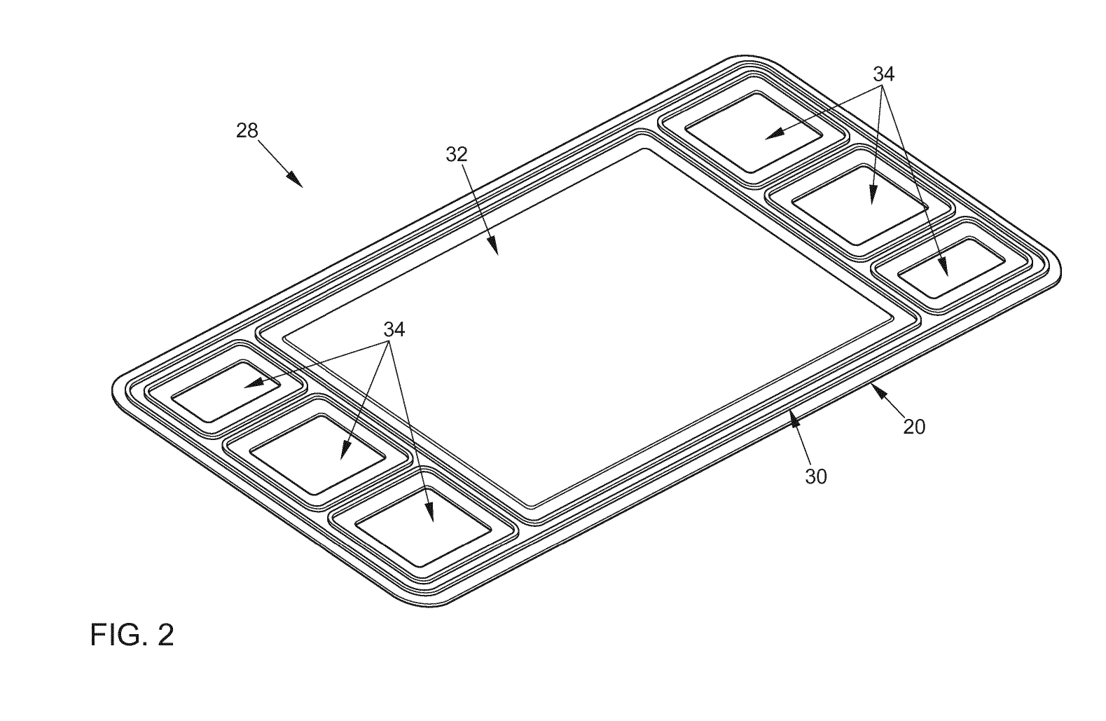

FIG. 2 shows a perspective view of a membrane electrode arrangement 28 according to the invention in an embodiment of the invention. Membrane electrode arrangement 28 comprises a membrane electrode assembly 20 (MEA) and a seal 30.

Membrane electrode assembly 20 typically has a chemically active region 32 and may also have openings 34 for the passage of operating media.

Chemically active region 32 and openings 34 for the passage of operating media may together be circumferentially surrounded by seal 30, as illustrated, and be easily separated from each other.

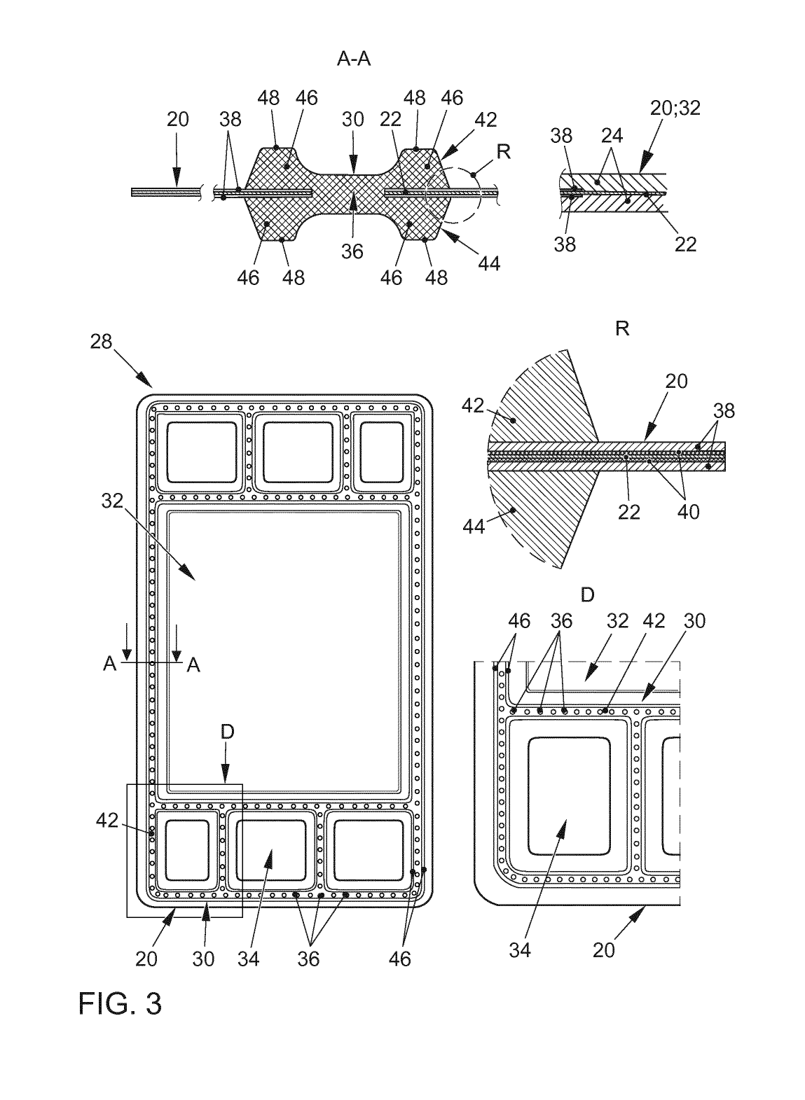

Additional details on the structure of membrane electrode arrangement 28 illustrated in FIG. 2 are explained below on the basis of FIG. 3. For this purpose, FIG. 3 shows a membrane electrode arrangement 28 according to the invention in a normal view with enlarged detail and sectional views in an exemplary embodiment of the invention.

In addition to the view shown in FIG. 2, a perforation 36 of membrane electrode assembly 20, which is actually covered by seal 30, is illustrated schematically in the top view, which is shown in an enlarged form in detailed view D. Perforation 36 may include a large number of recesses disposed at regular intervals, which penetrate membrane electrode assembly 20. The recesses may have, e.g., a circular shape, as shown, and are adapted to a particular application.

The structure of membrane electrode assembly 20 and seal 30 is apparent in the sectional view A-A, corresponding to a plane of intersection through one of the recesses of perforation 36.

In its chemically active region, membrane electrode assembly 20 typically includes a membrane 22 (polymer electrolyte membrane), which is disposed between two electrodes (anode or cathode), which are not illustrated, which may be designed as a catalytic coating of membrane 22. As illustrated, membrane electrode assembly 20 may also include two gas diffusion layers 24, which abut membrane 22 together with electrodes. According to an exemplary embodiment of the invention illustrated in FIG. 3, the electrodes and gas diffusion layers 24 are limited to chemically active region 32. This makes it possible to save material for the electrodes and gas diffusion layers 24. Membrane 22 typically passes planarly through chemically active region 32 and merges seamlessly with an edge region of membrane electrode assembly 20.

In the edge region, membrane 22 of membrane electrode assembly 20 is disposed between two edge reinforcing films 38, which form a so-called edge reinforcement. Edge reinforcing films 38 are used to mechanically stabilize typically very thin and resilient membrane 22. In the illustrated case, the edge reinforcement is also used as a support for seal 30. This detailed structure is apparent in detailed view R, which is enlarged once again compared to sectional view A-A. Edge reinforcing films 38 may be PEN films (polyethylene naphthalate) or include PEN. Edge reinforcing films 38 may furthermore be integrally connected to membrane 22 with the aid of an adhesive 40, e.g., an acrylic adhesive.

To facilitate a preferably stable transition between chemically active region 32 and the edge region, membrane electrode assembly 20 has a transitional region, in which edge reinforcing films 38 and gas diffusion layers 24 overlap.

In sectional view A-A, seal 30 is furthermore shown in a sectional representation. Seal 30 includes a first subsection 42, which is disposed on a first flat side of membrane electrode assembly 20, and a second subsection 44, which is disposed on a second flat side of membrane electrode assembly 20. The two subsections 42, 44 are connected to each other as a single piece through perforation 36. A form-locked mechanical joining of seal 30 to membrane electrode assembly 20 takes place via the recesses of perforation 36. In the sectional view A-A, first subsection 42 is disposed above the membrane electrode assembly, and second subsection 44 is disposed below the membrane electrode assembly. The two subsections 42, 44 may form a profiling, for example two sealing lips 46, as illustrated, each of sealing lips 46 having a sealing surface 48.

In the illustrated embodiment, sealing surfaces 48 of first subsection 42 and second subsection 44 have essentially congruent orthographic projection regions on the membrane electrode assembly. The two subsections 42, 44 are mirror-symmetrical with regard to a mirror plane, which in this case passes through membrane 22. This prevents, or at least reduces, a deformation of membrane electrode assembly 20 when seal 30 is pressed together within a fuel cell 10.

Membrane electrode assembly 20 may have a centering opening, which is not illustrated, for the passage of a centering rod. Electrically insulating spacing elements may be disposed on membrane electrode assembly 20, around this centering opening on both sides of membrane electrode assembly 20 and, in particular, on edge reinforcing films 38. The electrically insulating spacing elements are preferably applied in the same manufacturing step as the mounting of seal 30. In particular, the spacing elements may be made from the same material as seal 30. Similarly to seal 30, the spacing elements may run in a closed manner around the centering opening and be connected to each other as a single piece through another perforation. Due to the electrically insulating spacing elements, an electrically conductive contact of bipolar plates 26 adjacent to membrane electrode arrangement 28 is prevented within a fuel cell 10. Without spacing elements, bipolar plates 26 could project through the centering opening and make contact with each other, whereby a short circuit could occur.

Membrane electrode arrangement 28 according to the invention may be manufactured in that, for example, the profiled seal is overmolded onto the edge reinforcement of membrane electrode assembly 20 (the membrane electrode assembly 20 is insert-molded). For this purpose, membrane electrode assembly 20 is inserted into an opened injection molding die of an injection molding machine. The injection molding die is then closed and a non-cross-linked polymer or monomers is/are injected into the injection molding die to produce the elastomer of seal 30. This is followed by a heating of the polymer of seal 30 for a predetermined period of time to trigger the cross-linking and/or polymerization before the injection molding die is opened and membrane electrode arrangement 28 is removed. In particular, an integral connection between seal 30 and membrane electrode assembly 20, edge reinforcing films 38 in the illustrated case, may be achieved with the aid of this injection molding process.

If membrane electrode arrangement 28 according to the invention is disposed in a fuel cell 10, membrane electrode arrangements 28 and bipolar plates 26 are alternately stacked on each other to form a fuel cell stack 12. As discussed above, fuel cell 10 according to the invention may, in principle, have a structure according to FIG. 1, however it includes membrane electrode arrangements 28 according to the invention. Fuel cell stack 12 is pressed, so that seals 30 of membrane electrode arrangements 28 are compressed. As a result, seals 30, in particular their subsections 42, 44 on their sealing surfaces 48, seal spaces between one membrane electrode arrangement 28 and one bipolar plate 26 all the way around. The spaces include, in particular, chemically active regions 32 and the openings for the passage of operating media 34.

This preferably takes place in that the two subsections 42, 44 engage with grooves in the bipolar plates, i.e., are at least partially disposed therein and, in particular, in that sealing surfaces 48 are pressed against a groove base of the grooves. As a result, form-locked connections of seals 30 to adjacent bipolar plates 26 are established in addition to the form-locked or integral connections of seals 30 to membrane electrode assemblies 20. Seals 30 are thus insensitive to an offset of membrane electrode arrangement 28 with respect to bipolar plates 26, since the sealing lips seal against the sealing groove in the rigid bipolar plates.

With the aid of seal 30, it is possible to implement a seal of an, in particular, metallic fuel cell stack 12 with a cell spacing of approximately 1 mm (normal distance from the middle of one bipolar plate 26 to the middle of next bipolar plate 26 with membrane electrode arrangement 28 situated therebetween). This results in a height of a subsection 42 44 of seal 30 of only approximately 0.4 mm between the edge reinforcement and the bipolar plate in the pressed state.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A membrane electrode arrangement for a fuel cell, the arrangement comprising:
a membrane electrode assembly; and
a one-piece seal that has a first subsection and a second subsection, the first subsection being disposed on a first flat side and the second subsection being disposed on a second flat side of the membrane electrode assembly,
wherein the membrane electrode assembly has a perforation along which the seal extends on both sides of the membrane electrode assembly, and
wherein the first and second subsections are connected to each other as a single piece through the perforation.

2. The membrane electrode arrangement according to claim 1, wherein the first and second subsections have sealing surfaces, and wherein the sealing surfaces of the first subsection and the second subsection form essentially congruent, orthographic projection regions on the membrane electrode assembly.

3. The membrane electrode arrangement according to claim 1, wherein the membrane electrode assembly has an edge reinforcement in one edge region, at least on one of its flat sides, and wherein the seal extends along the edge reinforcement.

4. The membrane electrode arrangement according to claim 1, wherein a chemically active region of the membrane electrode assembly is circumferentially surrounded by the seal.

5. The membrane electrode arrangement according to claim 4, wherein the electrodes of the membrane electrode assembly are disposed at least essentially within the chemically active region that is circumferentially surrounded by the seal.

6. The membrane electrode arrangement according to claim 4, wherein the membrane electrode assembly includes gas diffusion layers, which are disposed within the chemically active region that is circumferentially surrounded by the seal.

7. The membrane electrode arrangement according to claim 1, wherein the membrane electrode assembly has at least one opening for the passage of operating media, which is circumferentially surrounded by the seal.

8. The membrane electrode arrangement according to claim 1, wherein the seal has two sealing lips.

9. The membrane electrode arrangement according to claim 1, wherein a plurality of membrane electrode arrangements are arranged in a fuel cell with a plurality of alternately stacked bipolar plates.

10. A fuel cell comprising a plurality of alternately stacked bipolar plates and a membrane electrode arrangement according to claim 1.

11. The fuel cell according to claim 10, wherein the bipolar plates have grooves, with which subsections of the seal engage.
